(19) United States
(12) Patent Application Publication
(10) Pub. No.: US 2004/0091776 A1
(43) Pub. Date: May 13, 2004

(54) Positive electrode for lithium sulfur battery and lithium sulfur battery comprising same

(75) Inventor: Duck-Chul Hwang, Suwon-city (KR)

Correspondence Address: STAAS & HALSEY LLP, SUITE 700, 1201 NEW YORK AVENUE, N.W., WASHINGTON, DC, 20005, US

(73) Assignee: SAMSUNG SDI CO., LTD., Suwon-city (KR)

(21) Appl. No.: 10/693,925

(22) Filed: Oct. 28, 2003

(30) Foreign Application Priority Data
Oct. 28, 2002 (KR) 2002-65775

(51) Int. Cl. H01M 4/58; B05D 3/02; H01M 2/16

(52) U.S. Cl. 429/218.1; 429/137; 427/372.2

(57) ABSTRACT

A positive electrode for a lithium sulfur battery and a lithium sulfur battery include a positive active material wiith a particle size D (v, 50%) of 10 μm or less, or has an average surface roughness Ra of 5 μm. The positive active material is selected from elemental sulfur (S₈), a sulfur-based compound, and a mixture thereof.

### CROSS-REFERENCE TO RELATED APPLICATIONS

This application is based on application No. 2002-65775 filed in the Korean Intellectual Property Office on Oct. 28, 2002, the disclosure of which is incorporated herein by reference.

### BACKGROUND OF THE INVENTION

1. Field of the Invention

The present invention relates to a positive electrode for a lithium sulfur battery and a lithium sulfur battery comprising the same, and more particularly, to a positive electrode for a lithium sulfur battery, exhibiting a higher capacity and effective cycle life characteristics and a lithium sulfur battery comprising the same.

2. Description of the Related Art

The development of portable electronic devices has led to a corresponding increase in the demand for secondary batteries having both a lighter weight and a higher capacity. To satisfy these demands, the most promising approach is a lithium-sulfur battery with a positive electrode made of sulfur-based compounds.

Lithium-sulfur batteries use sulfur-based compounds with sulfur-sulfur bonds as a positive active material, and a lithium metal or a carbon-based compound as a negative active material. The carbon-based compound is one which reversibly intercalates or deintercalates metal ions, such as lithium ions. Upon discharging (i.e., electrochemical reduction), the sulfur-sulfur bonds are cleaved, resulting in a decrease in the oxidation number of sulfur (S). Upon recharging (i.e., electrochemical oxidation), the sulfur-sulfur bonds are re-formed, resulting in an increase in the oxidation number of the S. The electrical energy is stored in the battery as chemical energy during charging and is converted back to electrical energy during discharging.

With respect to specific density, the lithium-sulfur battery is the most desirable among the currently developing batteries since lithium has a specific capacity of 3,830 mAh/g, and sulfur has a specific capacity of 1,675 mAh/g. Further, the sulfur-based compounds are less costly than other materials and are environmentally friendly.

However, employing a positive electrode based on elemental sulfur in an alkali metal-sulfur battery system has been considered problematic. Although theoretically the reduction of sulfur to an alkali metal-sulfide confers a large specific energy, sulfur is known to be an excellent insulator, and problems using sulfur as an electrode have been noted. Such problems include a very low percentage of utilization (i.e., low capacity) and a low cycle life characteristic as a result of sulfur and lithium sulfide (Li₂S) dissolved and diffused from the positive electrode.

Accordingly, there is a demand for provision of an improved lithium sulfur battery with a higher capacity and an extended cycle life.

### SUMMARY OF THE INVENTION

It is an aspect of the present invention to provide a positive electrode for a lithium sulfur battery, comprising a reduced particle size.

It is another aspect to provide a positive electrode for a lithium sulfur battery exhibiting a higher capacity and improved cycle life characteristics.

It is still another aspect to provide a lithium sulfur battery including the positive electrode.

These and/or other aspects may be achieved by a positive electrode for a lithium sulfur battery including a positive active material with a particle size D (v. 50%) of 10 μm or less. The positive active material is selected from elemental sulfur (S₈), a sulfur-based compound, or a mixture thereof. The positive electrode has an average surface roughness Ra of 5 μm or less.

To achieve these and/or other aspects, the present invention provides a lithium sulfur battery including the positive electrode, a negative electrode and an electrolyte. The negative electrode includes a negative active material selected from a material that reversibly intercalates or deintercalates lithium ions, a material that reacts with lithium ions to prepare a lithium-included compound, a lithium metal, or a lithium alloy.

Additional aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the preferred embodiments, taken in conjunction with the accompanying drawings of which:

FIG. 1 shows a scanning electron micrograph (SEM) of a positive electrode for a lithium sulfur battery according to Comparative Example 1;

FIG. 2 shows a SEM of a positive electrode for a lithium sulfur battery according to Example 2 of the present invention;

FIG. 3 shows a SEM of an electrode obtained from a lithium-sulfur battery according to Comparative Example 1 after 10 charge and discharge cycles;

FIG. 4 shows a SEM of an electrode obtained from a lithium-sulfur battery according to Example 3 of the present invention after 10 charge and discharge cycles; and

FIG. 5 is a schematic illustrating a collected portion of a sample of the electrode used for measuring surface roughness, and for SEMs before charge and discharge.

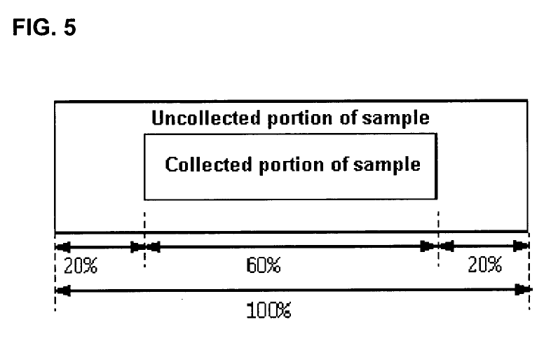

FIG. 6 is a block diagram illustrating a lithium/electrolyte/sulfur battery in accordance with an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A positive electrode for a lithium sulfur battery of an embodiment of the present invention includes a positive active material with a reduced particle size. Such a reduced particle size renders a high capacity and improved cycle life characteristics and decreased surface roughness.

The positive electrode of the present invention has a particle size D (v, 50%) of 10 μm or less, and preferably 1 to 5 μm. Alternatively, the positive electrode has an average surface roughness Ra of 5 □ or less, preferably 0.1 to 5 μm, and more preferably 0.2 to 4 μm, before the assembly of the battery. In this application, a term “D (v, 50%)” means a particle size in which particles distributed with various size such as 0.1, 0.2, 0.3 . . . 3, 5, 7, 10, 20, or 30 μm are accumulated to 50 volume %.

Conventionally, studies to control particle size of the positive active material in lithium ion batteries have been attempted (e.g., U.S. Pat. Nos. 5,958,362 and 5,718,844). However, particle size did not affect the capacity and the cycle life in lithium ion batteries, and the surface roughness did not affect capacity in lithium ion batteries as disclosed in U.S. Pat. No. 5,631,100.

After the cycle life test is done (that is, repeated charge and discharge cycles), the positive electrode of the present invention has an average roughness Ra of 0.1 μm or more and less than 15 μm, and preferably 0.1 to 8 μm. The repeated charge and discharge cycles are performed by charging at 0.1 to 2.0 C and discharging at 0.1 to 2.0 C, and preferably, by charging at 0.2 to 1.0 C and by discharging at 0.2 to 1.0 C. The charge rate is set to 0.1 to 2.0 mAh/cm³ and the discharge rate is set to 0.1 to 2.0 mAh/cm³.

The repeated charge and discharge cycles are performed for 1 to 100 times, preferably 5 to 100 times, and more preferably 5 to 20 times. The battery after the repeated charge and discharge cycles is presented in the condition of charge or discharge, or in the condition of being charged or discharged. The open circuit voltage (OCV) after the repeated charge and discharge cycles is 0.1 to 4.5 V and preferably 1.5 to 3.0 V.

In the positive electrode obtained from a lithium sulfur battery after the repeated charge and discharge cycles, an area of the positive active material is 10 to 90% based on the total area, preferably 20 to 80%, and more preferably 30 to 70%.

The positive active material includes elemental sulfur (S₈), a sulfur-based compound, or a mixture thereof. The sulfur-based compound is selected from Li₂Sₙ(n≧1), a organic-sulfur compound, or a carbon-sulfur polymer ((C₂Sₓ)ₙ: x=2.5 to 50, n≧2). The positive electrode may further include a coating layer including a polymer, an inorganic material, or a mixture thereof.

The polymer may include polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride-co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, a sulfonated styrene/ethylene-butylene/styrene triblock copolymer, polyethylene oxide or a mixture thereof.

The inorganic material includes colloidal silica, amorphous silica, a surface-treated silica, colloidal alumina, amorphous alumina, conductive carbon, tin oxide, titanium oxide, vanadium oxide, titanium sulfide (TiS₂), zirconium oxide (ZrO₂), iron oxide, iron sulfide (FeS), iron titanate (FeTiO₃), barium titanate (BaTiO₃), or a mixture thereof.

The negative electrode of the lithium-sulfur battery includes a negative active material selected from materials in which lithium intercalation reversibly occurs, a material which reacts with lithium ions to form a lithium-containing compound, a lithium metal, or a lithium alloy.

The materials in which lithium intercalation reversibly occurs are carbon-based compounds. Any carbon-based compound may be used as long as it is capable of intercalating and deintercalating lithium ions. Examples of such carbon materials include crystalline carbon, amorphous carbon, or a mixture thereof.

Examples of the material that reacts with lithium ions to form a lithium-containing compound include, but are not limited to, tin oxide (SnO₂), titanium nitrate, and Si. The lithium alloy includes an alloy of lithium and a metal selected from Na, K, Rb, Cs, Fr, Be, Mg, Ca, Sr, Ba, Ra, Al, or Sn.

The negative electrode may include an inorganic protective layer, an organic protective layer, or a mixture thereof, on a surface of lithium metal. The inorganic protective layer includes Mg, Al, B, C, Sn, Pb, Cd, Si, In, Ga, lithium silicate, lithium nitride (LixN: x=1 to 10), lithium borate, lithium phosphate, lithium phosphoronitride, lithium silicosulfide, lithium borosulfide, lithium aluminosulfide, or lithium phosphosulfide. The organic protective layer includes a conductive monomer, oligomer, or polymer selected from poly(p-phenylene), polyacetylene, poly(p-phenylene vinylene), polyaniline, polypyrroloe, polythiophene, poly(2,5-ethylene vinylene), acetylene, poly(perinaphthalene), polyacene, or poly(naphthalene-2,6-di-yl).

In addition, during charging and discharging of the lithium-sulfur battery, the positive active material (active sulfur) converts to an inactive material (inactive sulfur), which can be attached to the surface of the negative electrode. The term “inactive sulfur”, as used herein, refers to sulfur that has no activity upon repeated electrochemical and chemical reactions so it cannot participate in an electrochemical reaction of the positive electrode. The inactive sulfur on the surface of the negative electrode acts as a protective layer of the lithium negative electrode. Accordingly, inactive sulfur, for example, lithium sulfide, on the surface of the negative electrode may be used in the negative electrode.

The electrolyte includes an electrolytic salt and an organic solvent.

The organic solvent may be a sole solvent or a mixed organic solvent with at least two components. The mixed organic solvent includes at least two groups selected from a weak polar solvent group, a strong polar solvent group, or a lithium protection group.

The term “weak polar solvent”, as used herein, is defined as a solvent that is capable of dissolving elemental sulfur and has a dielectric coefficient that is less than 15. The weak polar solvent is selected from aryl compounds, bicyclic ether, or acyclic carbonate compounds. The term “strong polar solvent”, as used herein, is defined as a solvent that is capable of dissolving lithium polysulfide and has a dielectric coefficient that is greater than 15. The strong polar solvent is selected from bicyclic carbonate compounds, sulfoxide compounds, lactone compounds, ketone compounds, ester compounds, sulfate compounds or sulfite compounds. The term “lithium protection solvent”, as used herein, is defined as a solvent that forms a good protective layer, i.e. a stable solid-electrolyte interface (SEI) layer, on a lithium surface, and which shows a cyclic efficiency of at least 50%. The lithium protection solvent is selected from saturated ether compounds, unsaturated ether compounds, or heterocyclic compounds including N, O, and S.

Examples of the weak polar solvents include xylene, dimethoxyethane, 2-methyltetrahydrofurane, diethyl carbonate, dimethyl carbonate, toluene, dimethyl ether, diethyl ether, diglym, or tetraglyme.

Examples of the strong polar solvents include hexamethyl phosphoric triamide, γ-butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, or ethylene glycol sulfite.

Examples of the lithium protection solvents include tetrahydrofuran, 1,3-dioxolane, 3,5-dimethylisoxazole, 2,5-dimethyl furane, furane, 2-methyl furane, 1,4-oxane, and 4-methyldioxolane.

Examples of electrolyte salts include lithium trifluoromethane sulfonimide, lithium triflate, lithium perchlorate, LiPF₆, LiBF₄, tetraalkylammonium salts such as tetrabutylammonium tetrafluoroborate (TBABF₄), liquid state salts at room temperature, e.g., imidazolium salt such as 1-ethyl-3-methylimidazolium Bis-(perfluoroethyl sulfonyl) imide (EMIBeti), or a combination thereof.

The following examples illustrate the present invention in further detail, but it is understood that the present invention is not limited by these examples.

### EXAMPLE 1

S₈ powder was pulverized in an isopropylalcohol solvent with a zirconia ball for 24 hours, and the resulting material was dried at 80° C. for 1 hour to prepare a positive active material.

60 wt % of the positive active material, 20 wt % of a carbon conductive agent, and 20 wt % of a polyvinylpyrrolidone binder were uniformly mixed in an isopropylalcohol solvent.

The slurry was coated on a carbon-coated Al current collector. The coated collector was dried at room temperature for 2 hours, and was again dried at 50° C. for 12 hours to produce a positive electrode for a lithium sulfur battery.

### EXAMPLE 2

A positive electrode was produced by the same procedure as in Example 1, except that the pulverization was performed for 48 hours.

### EXAMPLE 3

A positive electrode was produced by the same procedure as in Example 1, except that the pulverization was performed for 72 hours.

### COMPARATIVE EXAMPLE 1

A positive electrode was produced by the same procedure as in Example 1, except that the S₈ powder without pulverization was used.

### COMPARATIVE EXAMPLE 2

A positive electrode was produced by the same procedure as in Example 1, except that the pulverization was performed for 3 hours.

The particle sizes of the positive active materials according to Examples 1 to 3 and Comparative Examples 1 to 2 were measured with a particle analyzer. The results are shown in Table 1.

TABLE 1

| | Pulverization | | Particle size | |
|---|---|---|---|---|
| | time | | D (v, 50%) | |
| Example 1 | 72 | hours | 4.7 | μm |
| Example 2 | 48 | hours | 5 | μm |
| Example 3 | 24 | hours | 10 | μm |
| Comparative Example 1 | 3 | hours | 20 | μm |
| Comparative Example 2 | 0 | | 58 | μm |

As shown in Table 1, as the pulverization time increases, the particle size decreases. However, when the pulverization is performed for longer than 48 hours, there is no further substantial decrease in the particle size. It is expected that the reduced particle size brings about an enlarged contact area between the electric conductive material and the positive active material, resulting in improving the battery performance.

SEM Photographs of the Positive Electrodes

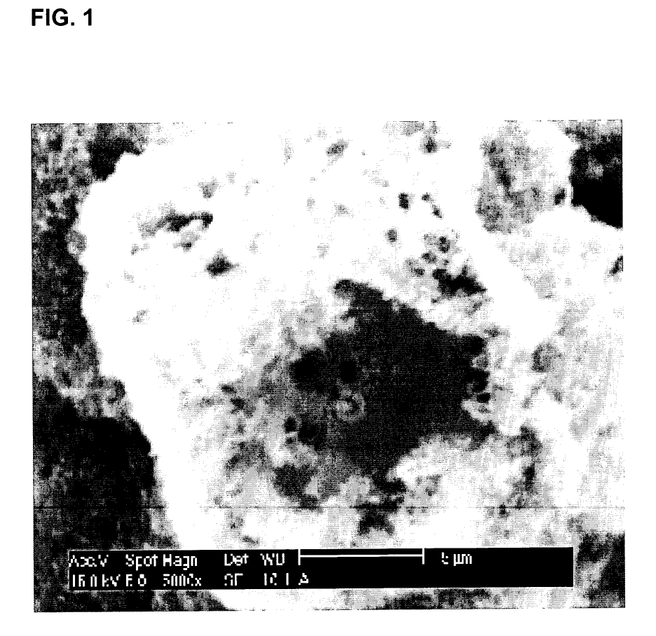

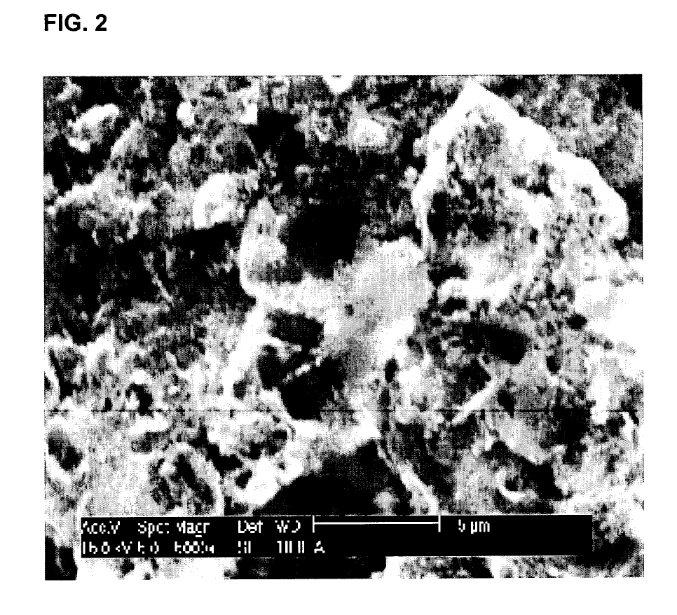

The SEM photographs of the positive electrodes according to Comparative Example 1 and Example 2 are presented in FIGS. 1 and 2, respectively. The particle size of the positive active material according to Comparative Example 1 in FIG. 1 was found to be about 10 to 25 μm, and that according to Example 2 was found to be about 2.5 to 4.5 μm. It is believed that the particle size is reduced slightly during the preparation of the slurry.

Surface Roughness of the Positive Electrode Before Charge and Discharge

The roughness of the positive electrodes according to Examples 1 to 3 and Comparative Examples 1 and 2 were measured and the results are shown in Table 2.

TABLE 2

| | Ra | Rq | Rz | Rt |
|---|---|---|---|---|
| Comparative Example 1 | 19 | 25 | 140 | 142 |
| Comparative Example 2 | 8.5 | 13 | 87 | 89 |
| Example 1 | 3.5 | 6.5 | 77 | 80 |
| Example 2 | 2.9 | 5.5 | 47 | 49 |

In Table 2, Rq indicates rms (root mean square) of each peak, Ra indicates arithmetic mean, and Rt indicates differences between highest and lowest. Rz indicates average roughness of 10-points and average roughness of five highest points and five lowest points. That is, the lower Ra and Rq indicate a uniform surface.

Thus, the positive electrodes according to Examples 1 and 2 have more uneven surfaces than the positive electrodes of Comparative Examples 1 and 2. This result indicates that the reduced particle size provides uniformity of the positive electrode and surface adhesion between the positive electrode and the separator, thus decreasing interfacial resistance and improving the battery performances.

Fabrication of Lithium Sulfur Cell

Using each positive electrode according to Examples 1 to 3 and Comparative Examples 1 to 2, a pouch-type lithium sulfur cell was fabricated by the following procedure. The size of the positive electrode was 25 mm×50 mm. The cell is a test cell with a higher capacity than a coin cell.

A tab was welded to the positive electrode, and the resulting positive electrode was positioned in a pouch. On the positive electrode, a separator was positioned. A tab-attached lithium foil was placed on the separator, and the pouch was sealed, except for an electrolyte inserting hole. 1M LiN(SO₂CF₃)₂ in dimethoxyethane/1,3-dioxolane (80/20 volume ratio) was injected into the pouch, and vacuum sealing was performed.

Measurement of Battery Performance

The cell was charged at 0.2 C and discharged at 0.5 C, and the battery performances were measured. The results are shown in Table 3.

TABLE 3

| | Particle | | | | Internal | |
|---|---|---|---|---|---|---|
| | size D | 1^{st} | 10^{th} | 10^{th} | resist- | |
| | (v, 50%) | capacity | capacity | cycle | ance | Area¹ |
| | μ | (mAh/g) | (mAh/g) | life (%) | (Ω) | (%) |
| Com- | 58 | 343 | 300 | 87 | 15.4 | 80 |
| parative | | | | | | |
| Example 1 | | | | | | |
| Com- | 20 | 400 | 360 | 90 | 13 | 70 |
| parative | | | | | | |
| Example 2 | | | | | | |
| Example 1 | 10 | 450 | 428 | 95 | 10.4 | 50 |
| Example 2 | 5 | 470 | 454 | 97 | 9.8 | 40 |

¹Indicates an area which positive active material covers after repeated charge and discharge (discharge state)

As shown in Table 3, the reduced particle size brings about better capacity and cycle life. As the particle size D (v, 50%) decreases, the internal resistance and the positive active material area are reduced before repeated charge and discharge. It is expected from these results that the cells according to Examples 1 and 2 exhibit more effective battery performance than the cells according to Comparative Examples 1 and 2. The OCV of the cells according to Examples 1 and 2 was 2.1 V before the repeated charge and discharge.

Separation Analysis

After the cycle life test (10 times charge and discharge) was done, the cell was separated and the central portion was sampled from the positive electrode. The central portion was a portion corresponding to 60%, with the exception of right and left 20% portions, when the total longitudinal direction length of the positive electrode is seen as 100%. The central portion was controlled to have a horizontal length of 1 to 5 cm and a vertical length of 1 to 5 cm. In addition, the central portion did not include the folded portion where the electrode was wound.

The central portion electrode was immersed in 150 ml of dimethoxyethane in a 200 ml beaker for 30 seconds, and then the electrode was taken from the beaker, followed by drying.

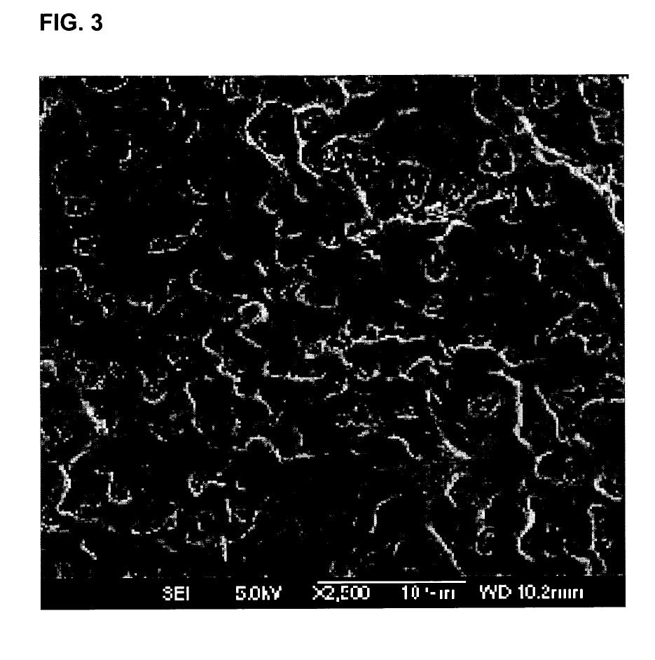

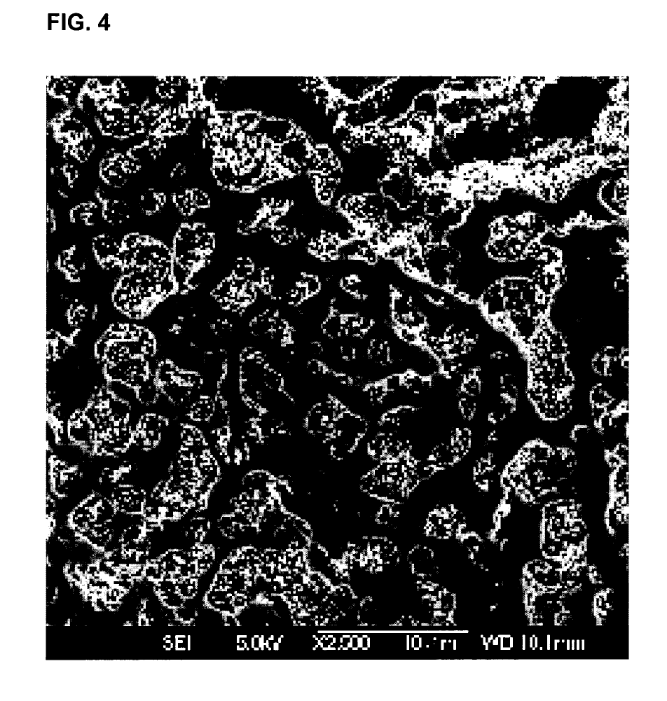

The SEMs of the positive electrode according to Comparative Example 1 are presented in FIGS. 3 and 4, respectively. SEMs after charge and discharge in FIGS. 3 and 4 indicate that positive active material was extracted to the surface of the electrode to partially cover the surface, when compared with SEMs before charge and discharge in FIGS. 1 and 2. The extracted positive active material has difficulty participating in the reaction of the battery, thus deteriorating battery performance. It is shown from FIGS. 3 and 4 that a smaller amount of positive active material is extracted to the surface according to Example 2 than in Comparative Example 3. It is expected from the result that the cell according to Example 2 has better battery performance than Comparative Example 3.

The surface roughness of the separated positive electrodes according to Examples 1 and 2 and Comparative Examples 1 and 2 were measured, and the results are shown in Table 4.

TABLE 4

| | Ra | Rq | Rz | Rt |
|---|---|---|---|---|
| Comparative Example 1 | 24 | 32 | 185 | 187 |
| Comparative Example 2 | 15 | 18 | 96 | 100 |
| Example 1 | 7.4 | 13.4 | 93 | 94 |
| Example 2 | 4.6 | 8.3 | 78 | 81 |

It is shown from Table 4 that, as the charge and the discharge were repeatedly performed, surfaces of all the positive electrodes gradually became uneven, but the positive electrodes (Examples 1 and 2) using active materials with smaller particle sizes (that is, smaller roughness) have lower increased roughness compared to the positive electrodes with larger particle sizes (Comparative Examples 1 and 2).

As a result, the positive active material with reduced particle size of the present invention allows a decrease in roughness of the positive electrode (19 μm of Ra is reduced to 2.9 μm), and increases in capacity from 343 mAh/g to 470 mAh/g and in cycle life from 87% to 97%).

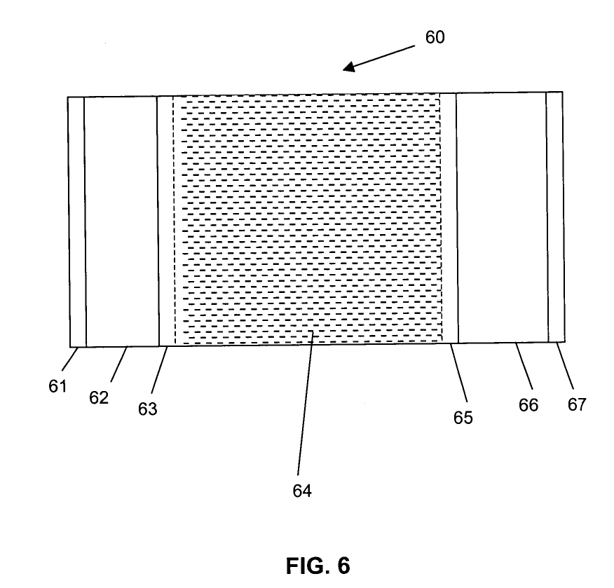

FIG. 6 is a block diagram illustrating a lithium/electrolyte/sulfur battery 60 in accordance with an embodiment of the present invention. The battery 60 includes a negative current collector 61 which is formed of a conductive material and serves to conduct electrons between a cell terminal (not shown) and a negative electrode 62 to which the current collector 61 is attached. Where desired, the negative electrode 62 may be coated, as described above, with a first protective layer 63. Either the negative electrode 62 or the first protective layer 63 contacts a liquid electrolyte in an electrolyte region 64. The electrolyte region 64 may be delineated by boundaries of a separator (not shown) which prevents electronic contact between the positive and negative electrodes. A positive electrode 66, or a second protective layer 65 that coats the positive electrode 66, abuts the side of the separator. Thus, the electrolyte region 64 is an electronic insulator and an ionic conductor so that the positive electrode 66 is ionically coupled to, but electronically insulated from the negative electrode 62. A current collector 67 comprises the electronic connection between the positive electrode 66 and a positive cell terminal (not shown).

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A positive electrode for a lithium sulfur battery comprising:
a positive active material with a particle size D (v, 50%) of approximately 10 μm or less, the positive active material being selected from the group consisting of elemental sulfur (S₈), a sulfur-based compound, and a mixture thereof.

2. The positive electrode of claim 1, wherein the particle size D (v, 50%) of the positive active material is approximately 1 to 5 μm.

3. The positive electrode of claim 1, wherein the positive electrode has an average surface roughness Ra of approximately 5 μm or less before assembly of the battery.

4. The positive electrode of claim 3, wherein the positive electrode has an average surface roughness Ra of approximately 0.1 to 5 μm before assembly of the battery.

5. The positive electrode of claim 4, wherein the positive electrode has an average surface roughness Ra of approximately 0.2 to 4 μm before assembly of the battery.

6. The positive electrode of claim 1, wherein the sulfur-based compound is selected from the group consisting of Li₂Sₙ(n≧1), Li₂Sₙ (n≧1) in catholyte, an organo-sulfur compound, and a carbon-sulfur polymer ((C₂Sₓ)ₙ: x=2.5 to 50, n≧2).

7. A positive electrode for a lithium sulfur battery having an average surface roughness Ra of approximately 5 μm or less before assembly of the battery.

8. The positive electrode of claim 7, wherein the positive electrode has an average surface roughness Ra of approximately 0.1 to 5 μm before assembly of the battery.

9. The positive electrode of claim 8, wherein the positive electrode has an average surface roughness Ra of approximately 0.2 to 4 μm before assembly of the battery.

10. A lithium sulfur battery comprising:
a positive electrode comprising a positive active material with a particle size D (v, 50%) of approximately 10 μm or less, the positive active material being selected from the group consisting of elemental sulfur (S₈), a sulfur-based compound and a mixture thereof;
a negative electrode comprising a negative active material selected from the group consisting of a material in which lithium intercalation reversibly occurs, a material that reacts with lithium ions to form a lithium-containing compound, a lithium metal, and a lithium alloy; and
an electrolyte.

11. The lithium sulfur battery of claim 10, wherein the positive electrode of claim 1, wherein the particle size D (v, 50%) of the positive active material is approximately 1 to 5 μm.

12. The lithium sulfur battery of claim 10, wherein the positive electrode has an average surface roughness Ra of approximately 0.1 to 5 μm before assembly of the battery.

13. The lithium sulfur battery of claim 12, wherein the positive electrode has an average surface roughness Ra of approximately 0.2 to 4 μm before assembly of the battery.

14. The lithium sulfur battery of claim 10, wherein the positive electrode has an average surface roughness Ra of approximately 0.1 to 15 μm in a central portion after a cycle life test of the battery is done.

15. The lithium sulfur battery of claim 14, wherein the positive electrode has an average surface roughness Ra of approximately 0.1 to 8 μm in the central portion after a cycle life test of the battery is done.

16. The lithium-sulfur battery of claim 10, wherein the central portion is a portion corresponding to 60% with an exception of right and left 20% portions, when a total longitudinal direction length of the positive electrode is 100%, and the central portion does not include a folded portion where an electrode is wound.

17. The lithium sulfur battery of claim 14, wherein the cycle life test is performed by charging at 0.1 to 2.0 C and by discharging at 0.1 to 2.0 C.

18. The lithium sulfur battery of claim 17, wherein the cycle life test is performed by charging at 0.2 to 1.0 C and by discharging at 0.2 to 2.0 C.

19. The lithium sulfur battery of claim 14, wherein the cycle life test is performed at a charge rate of 0.1 to 2.0 mAh/cm² and at a discharge rate of 0.2 to 1.0 mAh/cm².

20. The lithium sulfur battery of claim 14, wherein the cycle life test is performed by charging and discharging for 1 to 100 times.

21. The lithium sulfur battery of claim 20, wherein the cycle life test is performed by charging and discharging for 5 to 100 times.

22. The lithium sulfur battery of claim 21, wherein the cycle life test is performed by charging and discharging for 5 to 20 times.

23. The lithium sulfur battery of claim 14, wherein the battery is presented in a condition of charge or discharge after the cycle life test is done.

24. The lithium sulfur battery of claim 14, wherein the battery is presented in a condition of being charged or being discharged after the cycle life test is done.

25. The lithium sulfur battery of claim 14, wherein the battery has an open circuit voltage of 1.0 to 4.5 V after the cycle life test is done.

26. The lithium sulfur battery of claim 25, wherein the battery has an open circuit voltage of 1.5 to 3.0 V after the cycle life test is done.

27. The lithium sulfur battery of claim 14, wherein the positive active material is presented in an area of 10 to 90% based on a total area in the positive electrode after the cycle life is done.

28. The lithium sulfur battery of claim 27, wherein the positive active material is presented in an area of 20 to 80% based on the total area in the positive electrode after the cycle life is done.

29. The lithium sulfur battery of claim 28, wherein the positive active material is presented in an area of 30 to 70% based on the total area in the positive electrode after the cycle life is done.

30. The lithium sulfur battery of claim 10, wherein the sulfur-based compound is selected from the group consisting of Li₂Sₙ(n≧1), Li₂Sₙ (n≧1) in catholyte, an organo-sulfur compound and a carbon-sulfur polymer ((C₂Sₓ)ₙ: x=2.5 to 50, n≧2).

31. The lithium sulfur battery of claim 10, wherein the positive electrode further comprises a coating layer, the coating layer comprising a polymer, an inorganic material or a mixture thereof.

32. The lithium sulfur battery of claim 31, wherein the polymer is selected from the group consisting of polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-co-ethyl acrylate), polyacrylonitrile, polyvinyl chloride-co-vinyl acetate, polyvinyl alcohol, poly(1-vinylpyrrolidone-co-vinyl acetate), cellulose acetate, polyvinyl pyrrolidone, polyacrylate, polymethacrylate, polyolefin, polyurethane, polyvinyl ether, acrylonitrile-butadiene rubber, styrene-butadiene rubber, acrylonitrile-butadiene styrene, a sulfonated styrene/ethylene-butylene/styrene triblock copolymer, polyethylene oxide, and a mixture thereof.

33. The lithium sulfur battery of claim 31, wherein the inorganic material is selected from the group consisting of colloidal silica, amorphous silica, a surface-treated silica, colloidal alumina, amorphous alumina, conductive carbon, tin oxide, titanium oxide, vanadium oxide, titanium oxide, zirconium oxide, iron oxide, iron sulfide, iron titanate, barium titanate, and a mixture thereof.

34. A method of producing a positive electrode of a lithium sulfur battery, comprising:
pulverizing S₈ powder in an isopropylalcohol solvent for approximately 72 hours, and drying a resulting material at approximately 80° C. for approximately 1 hour to prepare a positive active material;
mixing 60 wt % of the positive active material, 20 wt % of a carbon conductive agent, and 20 wt % of a polyvinylpyrrolidone binder uniformly in an isopropyl alcohol solvent to form a slurry;
coating the slurry was on a carbon-coated Al current collector; and
drying the coated collector at room temperature for approximately 2 hours, and again drying the coated collector at approximately 50° C. for approximately 12 hours to produce the positive electrode.

35. The method of claim 34, wherein pulverizing the S₈ powder is performed for approximately 48 hours.

36. The method of claim 34, wherein pulverizing the S₈ powder is performed for approximately 24 hours.
